(19) United States
(12) Patent Application Publication
(10) Pub. No.: US 2014/0054393 A1
(43) Pub. Date: Feb. 27, 2014

(54) MOVABLE IRRIGATION MACHINE

(71) Applicant: Tung-Tsuan Tsai, Taichung City (TW)

(72) Inventor: Tung-Tsuan Tsai, Taichung City (TW)

(21) Appl. No.: 13/595,009

(22) Filed: Aug. 27, 2012

(51) Int. Cl. B05B 1/24; B09C 1/06; A01G 25/09

(52) U.S. Cl. 239/130

(57) ABSTRACT

A movable irrigation machine contains a machine body including plural wheels; a heating system including a supporting frame and plurality heat devices; a gas cylinder to supply gas toward the heat devices. Each heat device has an inlet for flowing water inwardly, an outlet for flowing heated water outwardly, and a gas intake for feeding gas into the each heat device; a first heat device on a right side of the heat devices has an inflow tube connected with an inlet of the first heat device; a second heat device on a left side of the heat devices has an outflow tube coupled with an outlet of the second heat device; the first heat device has a connecting pipe coupled with the outlet thereof and an inlet of a third heat device on a middle portion of the heat devices, and the third heat device has an outlet.

### FIELD OF THE INVENTION

The present invention relates to a movable irrigation machine which allows heating water and spraying heated water to soils so that bacteria and insects in the soils are killed, thus saving time and cost in soils cleaning process.

### BACKGROUND OF THE INVENTION

A cleaning device for soils on disclosed in TW Publication No. M378046 contains purifying device for transporting soils inwardly to sterilize bacteria and insects in the soils by ways of a high temperature and water vapors. Thereafter, cleaned soils are carried back to the cultivation area to grow plants.

Nevertheless, such soil depuration will spend a lot of labors and time, thus increasing planting cost and time.

The present invention has arisen to mitigate and/or obviate the afore-described disadvantages.

### SUMMARY OF THE INVENTION

The primary object of the present invention is to provide a movable irrigation machine which allows heating water and spraying heated water to soils so that bacteria and insects in the soils are killed, thus saving time and cost in soils cleaning process.

To obtain the above objective, a movable irrigation machine provided by the present invention contains:

a machine body including a plurality of wheels disposed on a bottom end thereof to move the irrigation machine;

a heating system including a supporting frame fixed between the two handles of the machine body and a plurality of heat devices secured in the supporting frame;

a gas cylinder secured on the machine body and connecting with the air pipe to supply gas toward the plurality of heat devices; wherein

each heat device has an inlet for flowing water inwardly, an outlet for flowing heated water outwardly, and a gas intake for feeding gas into the each heat device as a heating source;

a first heat device on a right side of the plurality of heat devices has an inflow tube connected with an inlet of the first heat device and a water supply;

a second heat device on a left side of the plurality of heat devices has an outflow tube coupled with an outlet of the second heat device and the water supply;

the first heat device has a connecting pipe coupled with the outlet thereof and an inlet of a third heat device on a middle portion of the plurality of heat devices, and the third heat device has an outlet connected with a connecting pipe thereof and an inlet of the second heat device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a movable irrigation machine according to a first embodiment of the present invention.

FIG. 2 is a cross sectional view showing the assembly of the movable irrigation machine according to the first embodiment of the present invention.

FIG. 3 is a side plan view showing the assembly of a heating system of the movable irrigation machine according to the first embodiment of the present invention.

FIG. 4 is a side plan view showing the assembly of a heating system of a movable irrigation machine according to a second embodiment of the present invention.

FIG. 5 is a perspective view showing the assembly of the heating system of the movable irrigation machine according to the second embodiment of the present invention.

### DETAILED DESCRIPTION OF THE PREFERRED EMBODIMENTS

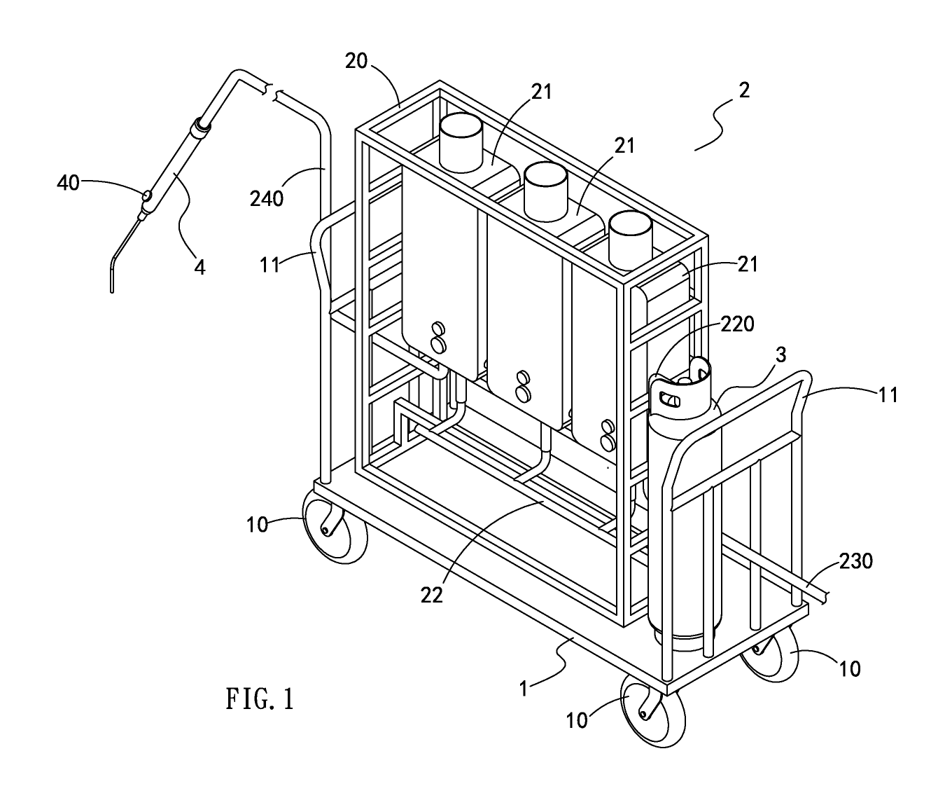

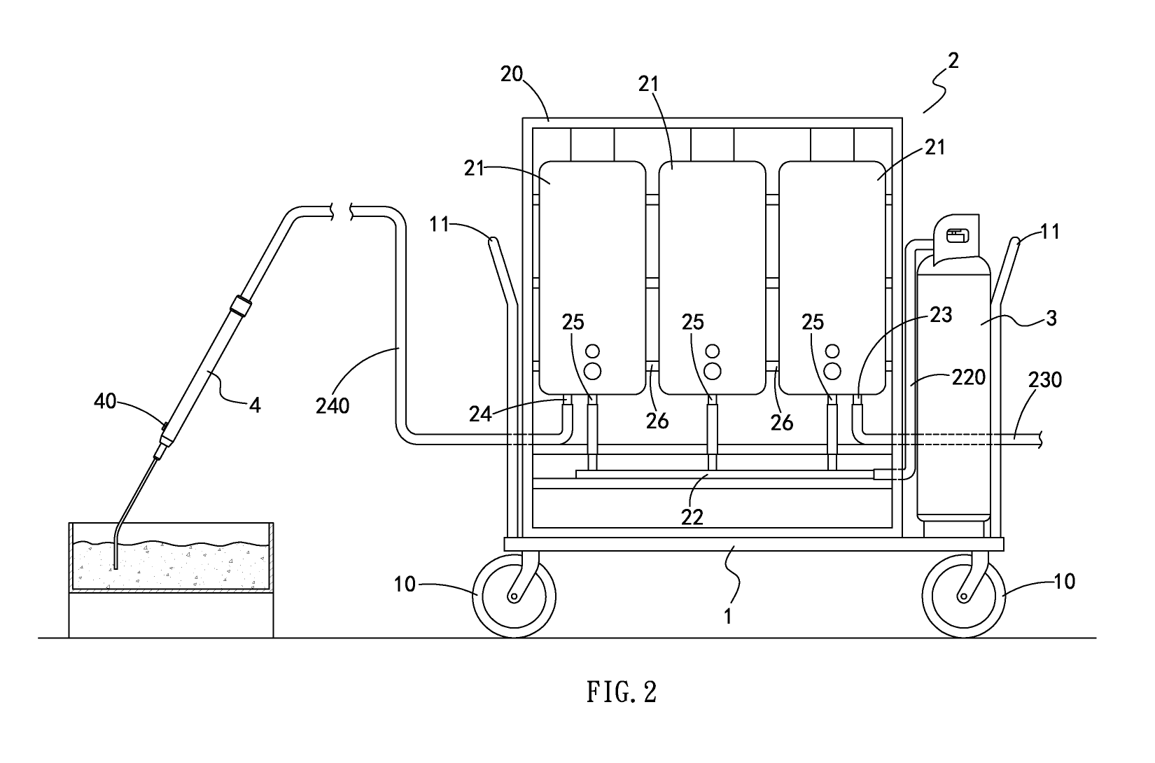

FIG. 1 is a perspective view showing the assembly of a movable irrigation machine according to a first embodiment of the present invention. FIG. 2 is a cross sectional view showing the assembly of the movable irrigation machine according to the first embodiment of the present invention. The movable irrigation machine of the first embodiment comprises a machine body 1, a heating system 2, a gas cylinder 3, and a water sprayer 4.

The machine body 1 includes a plurality of wheels 10 disposed on a bottom end thereof and two handles 11 mounted on two opposite sides of a top end thereof so that the machine body 1 is moved by pushing or pulling the two handles 11.

The heating system 2 includes a supporting frame 20 fixed between the two handles 11 of the machine body 1, three heat devices 21 secured in the supporting frame 20, and a conducting tube 22 connecting with the supporting frame 20, wherein each heat device 21 has an inlet 23 for flowing water inwardly, an outlet 24 for flowing heated water outwardly, and a gas intake 25 for feeding gas into the each heat device 21 as a heating source. A first heat device 21 on a right side of the three heat devices 21 has an inflow tube 230 connected with an inlet 23 of the first heat device 21 and a water supply. A second heat device 21 on a left side of the three heat devices 21 has an outflow tube 240 coupled with an outlet 24 of the second heat device 21 and the water supply. The first heat device 21 has a connecting pipe 26 coupled with the outlet 24 thereof and an inlet 23 of a third heat device 21 on a middle portion of the three heat devices 21, and the third heat device 21 has an outlet 24 connected with a connecting pipe 26 thereof and an inlet 23 of the second heat device 21, such that the three heat devices 21 are connected together.

The conducting tube 22 includes a first hole and three second holes communicating with the first hole, and the first hole has an air pipe 220 coupled therewith and the three second holes couple with three gas intakes 25 of the three heat device 21 via a pipe fitting.

The gas cylinder 3 is secured on the machine body 1 and is in connection with the air pipe 220 to supply gas toward the three heat devices 21.

The water sprayer 4 couples with the outflow tube 240 of the second heat device 21 to spray the heated water outwardly and includes an on/off valve 40 to control a water flow of the heated water.

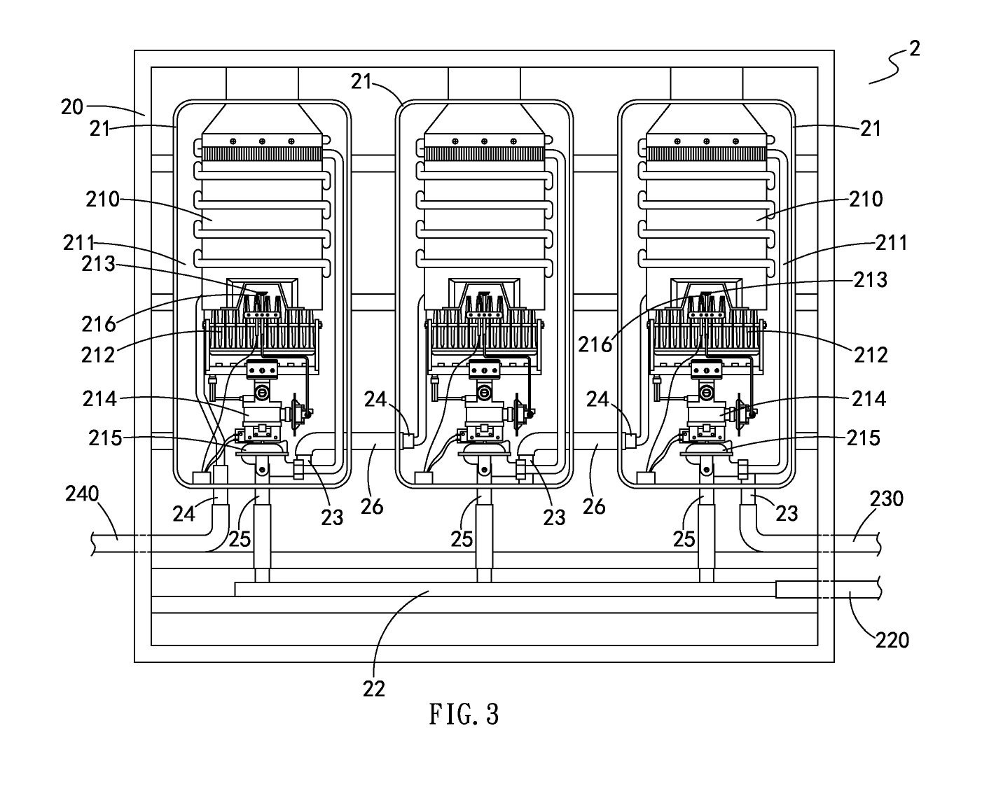

Referring further FIG. 3, each heat device 21 includes a water tank 210, and the water tank 210 has a heating pipe 211 connected with the inlet 23 and the outlet 24 of the each heat device 21, a fire row arrangement 212, a mouth 213, a gas overlock 214, a pressure disc 215, and an ignition 216.

When water flows into the pressure disc 215 from the inlet 23, a water pressure drives the pressures disc 215 and the gas overlock 214 so that the gas flows into the mouth 213 from the gas intake 215, and the ignition 216 starts the mouth 213 to light a fire, the gas from the gas intake 25 flows into the fire row arrangement 212 so that the fire ignites the gas which flows into the fire row arrangement 212, and then water in the water tank 210 is therefore heated and flows out of the outlet 24.

It is to be noted that a number of the heat device 21 can be two, four or more than four based on using requirement.

In addition, the each heat device 21 is a gas water heater.

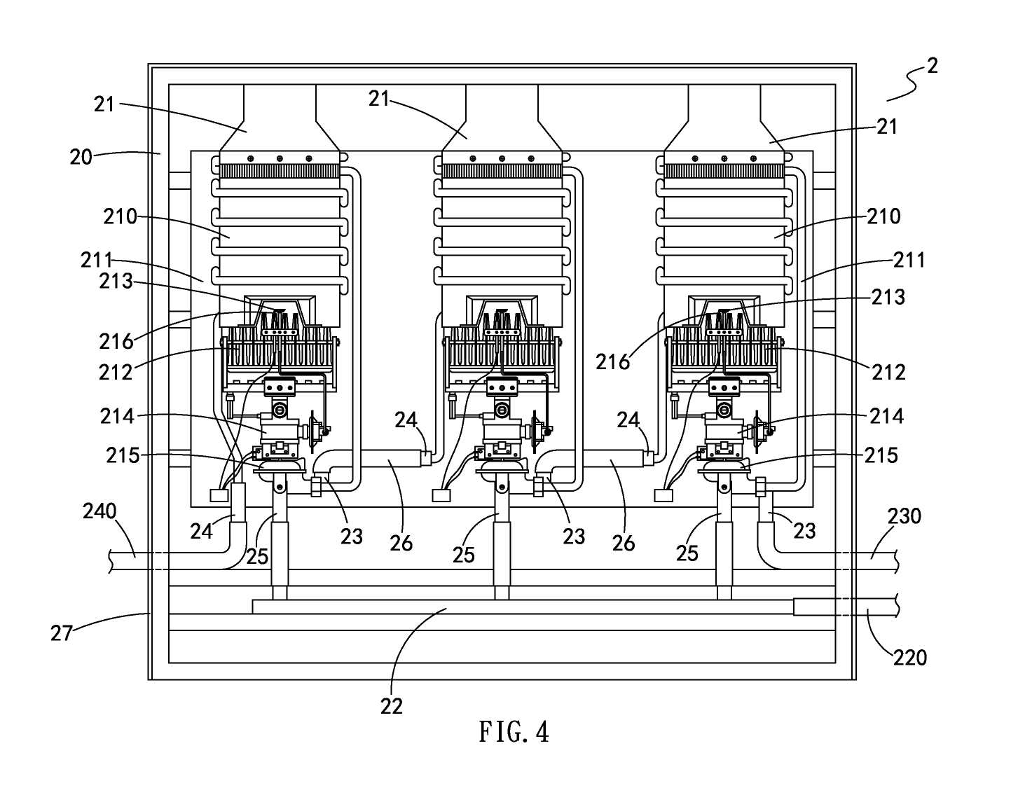

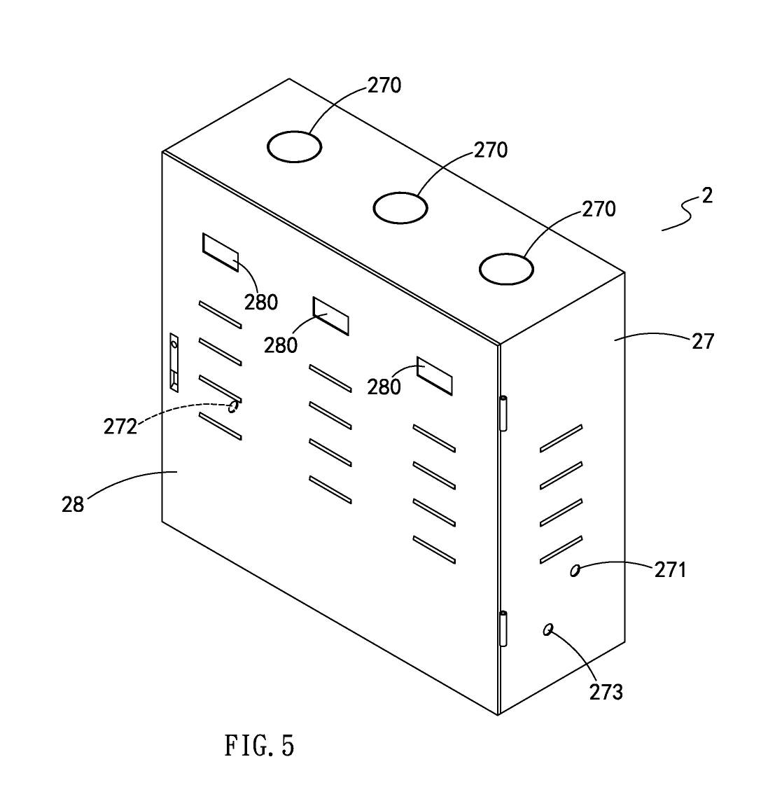

With reference to FIGS. 4 and 5, a difference of a movable irrigation machine of a second embodiment of the present invention from the first embodiment comprises: a heating system 2 having a housing 28 and a protective door 28.

The housing 27 is fixed on a machine body 1 to surround a sporting frame 20 in which a plurality of heat devices 21 are arranged, the housing 27 includes a first opening defined on one side thereof.

The protective door 28 is connected with the supporting frame 20 to cover the first opening of the housing 27.

The housing 27 also includes three air ventilations 270 defined on a top surface thereof and aligning with the three hest devices 21 to exhaust heat, an inflow orifice 271 defined on a right side thereof to insert the inflow tube 230, an outflow orifice 272 defined on a left side thereof to insert the outflow tube 240, and a gas aperture 273 defined on the right side thereof to insert the air pipe 220. The protective door 28 includes three second openings 280 defined thereon and aligning with the three heat devices 21 so that a user allows viewing the fire.

Due to the heating system 2 and the gas cylinder 3 are fixed on the machine body 1, when the machine body 1 moves toward any desired position, the heating system 2 heats water and sprays the heated water to soils so that bacteria and insects in the soils are killed, thus saving time and cost in soils cleaning process.

Preferably, the heating system 2 includes the plurality of heat devices 21 to heat the water quickly, thereby saving gas consumption.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A movable irrigation machine comprises:
a machine body including a plurality of wheels disposed on a bottom end thereof to move the irrigation machine;
a heating system including a supporting frame fixed between the two handles of the machine body and a plurality of heat devices secured in the supporting frame;
a gas cylinder secured on the machine body and connecting with the air pipe to supply gas toward the plurality of heat devices; wherein
each heat device has an inlet for flowing water inwardly, an outlet for flowing heated water outwardly, and a gas intake for feeding gas into the each heat device as a heating source;
a first heat device on a right side of the plurality of heat devices has an inflow tube connected with an inlet of the first heat device and a water supply;
a second heat device on a left side of the plurality of heat devices has an outflow tube coupled with an outlet of the second heat device and the water supply;
the first heat device has a connecting pipe coupled with the outlet thereof and an inlet of a third heat device on a middle portion of the plurality of heat devices, and the third heat device has an outlet connected with a connecting pipe thereof and an inlet of the second heat device.

2. The movable irrigation machine as claimed in claim 1 further comprising a water sprayer coupling with the outflow tube of the second heat device to spray the heated water outwardly and including an on/off valve to control a water flow of the heated water.

3. The movable irrigation machine as claimed in claim 1, wherein the heating system includes a conducting tube connecting with the supporting frame and includes a first hole and three second holes communicating with the first hole, and the first hole has an air pipe coupled therewith and the three second holes couple with three gas intakes of the three heat device via a pipe fitting.

4. The movable irrigation machine as claimed in claim 1, wherein the machine body also includes two handles mounted on two opposite sides of a top end thereof so that the machine body is moved by pushing or pulling the two handles.

5. The movable irrigation machine as claimed in claim 3, wherein each heat device includes a water tank, and the water tank has a heating pipe connected with the inlet and the outlet of the each heat device, a fire row arrangement, a mouth, a gas overlock, a pressure disc, and an ignition; when water flows into the pressure disc from the inlet, a water pressure drives the pressures disc and the gas overlock so that the gas flows into the mouth from the gas intake, and the ignition starts the mouth to light a fire, the gas from the gas intake flows into the fire row arrangement so that the fire ignites the gas which flows into the fire row arrangement, and then water in the water tank is therefore heated and flows out of the outlet.

6. The movable irrigation machine as claimed in claim 3, wherein a number of the plurality of heat devices is three.

7. The movable irrigation machine 1 as claimed in claim 5, wherein the each heat device is a gas water heater.

8. The movable irrigation machine as claimed in claim 5, wherein the heating system contains: a housing fixed on a machine body to surround a sporting frame in which a plurality of heat devices are arranged, the housing includes a first opening defined on one side thereof; a protective door connected with the supporting frame to cover the first opening of the housing.

9. The movable irrigation machine as claimed in claim 8, wherein the protective door also includes three second openings defined thereon and aligning with the three heat devices so that a user allows viewing the fire.

10. The movable irrigation machine as claimed in claim 8, wherein the housing also includes three air ventilations defined on a top surface thereof and aligning with the three hest devices to exhaust heat, an inflow orifice defined on a right side thereof to insert the inflow tube, an outflow orifice defined on a left side thereof to insert the outflow tube, and a gas aperture defined on the right side thereof to insert the air pipe.
